(19) United States
(12) Patent Application Publication
(10) Pub. No.: US 2008/0251309 A1
(43) Pub. Date: Oct. 16, 2008

(54) All Wheel Steering Scooter

(76) Inventors: Stefan Lippert, Esslingen (DE); Alexander Elizov, St. Petersburg (RU)

Correspondence Address: FAY KAPLUN & MARCIN, LLP, 150 BROADWAY, SUITE 702, NEW YORK, NY, 10038, US

(21) Appl. No.: 10/588,045

(22) PCT Filed: Jan. 18, 2006
(86) PCT No.: PCT/DE2006/000115

§ 371 Date: Aug. 1, 2006

(30) Foreign Application Priority Data
Sep. 14, 2005 (DE) 10 2005 044 661.2

(51) Int. Cl. A61G 5/04

(52) U.S. Cl. 180/212

(57) ABSTRACT

Described is a vehicle for handicapped persons, thus persons who are limited in their mobility. They may be provided with a seat, but may also be used when standing. The vehicle includes a steerable front wheel and two rear wheels. The rear wheels are in each case individually held in a wheel suspension on a frame. Furthermore, a separately controllable steering drive is present for each rear wheel.

### FIELD OF INVENTION

The present invention relates to a vehicle for handicapped people who are limited in their mobility. It may also be equipped with a seat as well as being used in a standing position when it has been accordingly designed.

### BACKGROUND INFORMATION

Such vehicles are usually equipped with three or also four wheels. They may be articulated and often electrically driven, so that the radius of mobility may be extended. Electrical controls are also often present, so that a use by greatly handicapped persons is also possible.

With the known vehicles however, the possibilities on travelling are limited and direction changes are only possible when adhering to the minimum curve radii.

### SUMMARY OF INVENTION

The present invention relates to increasing the flexibility of vehicles for handicapped persons.

A vehicle for handicapped persons may be maneuvered in the most restricted spaces with the invention. Furthermore, travel perpendicular to the longitudinal axis of the vehicle and also a rotation about an axis of the vehicle are possible. In the latter case, a vehicle according to the present invention turns, without having to adhere to a minimum radius, so that the space required for turning is exclusively determined by the external dimensions of the vehicle.

For this, the vehicle according to the invention is designed such that in total at least three steerable wheels are present, thus a front wheel and two rear wheels. The rear wheels thereby are held individually on a frame with its own wheel suspension, and a separate, controllable steering drive is present on each rear wheel, so that the rear wheels may be pivoted individually and independently of one another, even in different directions and at different angles.

Thereby they should be able to be pivoted by at least 90°, possible however by up to 180°.

The rear wheels are also advantageously individually driven. The drives may be electrical wheel hub motors which likewise may be actuated individually. Thus the possibility exists of also driving them in a different rotational direction when required.

A separate steering drive may however also be present at the front wheel, which likewise may be electrically driven and controlled.

In a more simple embodiment however, a front wheel held in a fork may be manually articulated to a steering rod connected to the fork.

Additional elements useful for the control may be present on a steering rod or on another location of the vehicle.

Thus at least one, but preferably two rotational angle sensor(s) may be present, which may be used for the control of the vehicle. Thus a rotational angle sensor provides a signal on the pivot angle of the front wheel. This signal may be used via an electronic control for the activation of the two steering drives and the drive of the rear wheels.

A further rotational angle sensor or another suitable sensor may be utilised for the control of the travelling speed and/or of the rotational direction of the rear wheel drives. This may for example be influenced by a pivoting of the steering rod. Thus a pivoting of the steering rod parallel to the longitudinal axis of the fork may influence the respective rotational direction of the drives for the rear wheels and, depending on the pivot angle, also the rotational speed and thus the travelling speed.

A vehicle according to the present invention may however also comprise four steerable wheels, wherein in this case the front wheels may be suspended, driven and steered in an analogous form to the rear wheels. Thus also two steering drives may be present for the two front wheels which may also be controlled in this manner.

Furthermore, a change-over switch may be present, installed preferably on the steering rod. Certain travel modes may be selected via the electronic control with such a change-over switch. Thus the rear wheels may be pivoted such that they are aligned parallel to one another. A travel of the vehicle perpendicular to its own longitudinal axis is then possible with a suitable position of the front wheel, which may be required in narrow corridors in which a turning or a curved travel of the vehicle is not possible.

In another form, a rotation of the vehicle about its own axis may be effected in a selected travel mode. For this, the rear wheels are obliquely pivoted oppositely to one another in each case at a certain angle, and the rotational direction of the drives for the rear wheels may be selected accordingly, wherein the drives are then operated with opposite rotational directions, although the rear wheels rotate in the same direction.

In normal operation too, the steering drives of the rear wheels may be activated, so that they co-steer the rear wheels with normal curved travel. Thereby, the rear wheels may be directed outwards independently of one another with different angles depending on the respective curve radius, so that each wheel may follow the optimal curve radius.

### BRIEF DESCRIPTION OF DRAWINGS

FIG. 1 shows an exemplary embodiment of a vehicle according to the present invention, for a normal travel mode;

FIG. 2 shows the vehicle according to FIG. 1 for a travel mode with a progressive movement direction perpendicular to the vehicle axis;

FIG. 3 shows the vehicle according to FIG. 1 for a travel mode for a rotation about its own axis;

FIG. 3a shows the position of the wheels in the travel mode for a rotation;

FIG. 4 shows the vehicle according to FIG. 1 for an oblique travel with regard to the longitudinal axis of the vehicle and

FIG. 4a shows the position with an oblique travel.

### DETAILED DESCRIPTION

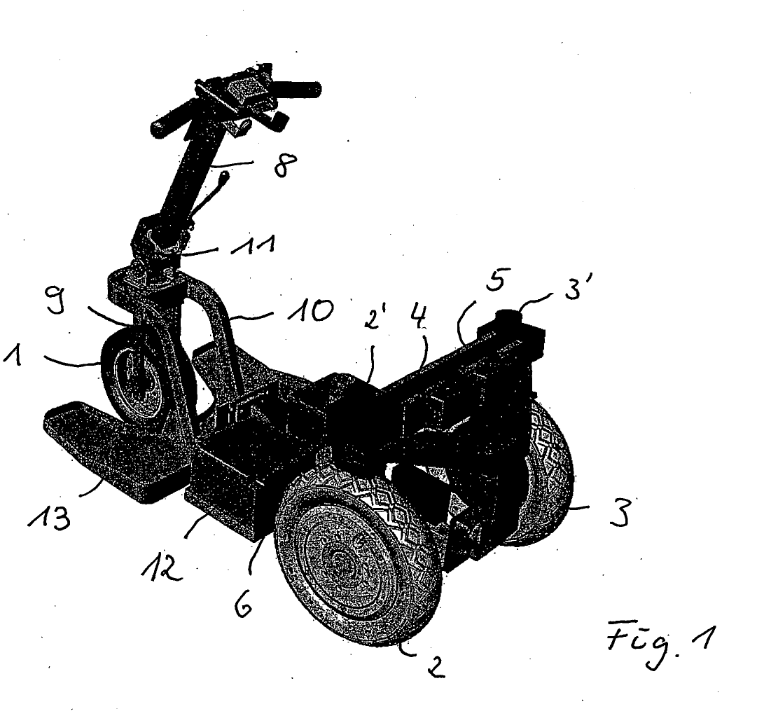

A steerable front wheel 1 and two likewise steerable rear wheels 2 and 3 are present with the example of a vehicle according to the present invention for handicapped persons shown in FIG. 1. The front wheel is held in a fork 9 which may be pivoted by way of a steering rod 8 together with the front wheel 1. The steering rod 8 and fork 9 are connected to a cardan joint 11. For this, one may also apply a suitable homocinetic joint. By way of this, a pivoting of the steering rod 8 parallel to the axis of the fork 9 is also possible, in order to be able to additionally control the vehicle as explained in the general part of the description.

On the frame 10 of the vehicle, wheel suspensions 6 and 7 for the rear wheels 2 and 3 are present, and for each of the rear wheels 2 and 3 its own steering drive 4 and 5. The steering drives 4 and 5 with this example are aligned transversely to the longitudinal axis of the vehicle and are designed as electrical linear drives which are activated by an electronic control which is not shown. The drives engage on shafts 2′ and 3′ behind the rear wheel suspensions 6 and 7, via which a pivoting may be effected on steering the rear wheels 2 and 3. Thereby, a gear transmission may be arranged therebetween, in order to be able to provide the required torques.

The drives for the rear wheels 2 and 3 are electrical wheel hub motors which are likewise controlled.

Here two electro-energy storers 12 and a step surface 13 are fastened on the frame 10. A seat may also be fastened on the frame 10 in a manner which is likewise not shown. In this case, it may be advantageous to design the steering rod 8 in the form of a telescope, so that an ergonomic use of the vehicle is possible on sitting as well as when standing.

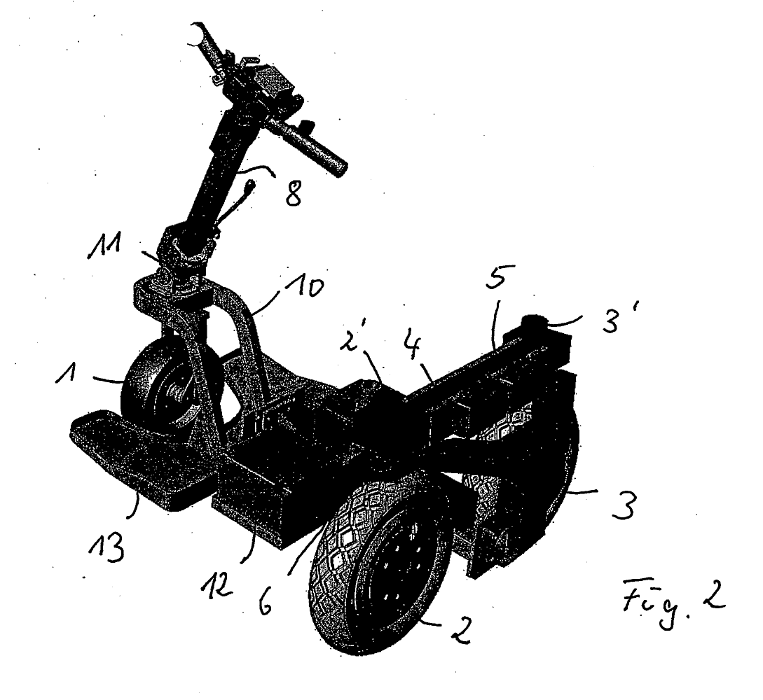

FIG. 2 is to show how a pivoting of the rear wheels 2 and 3 by way of the steering drives 4 and 5 may be effected on switching to a travel mode for a travel perpendicular to the longitudinal axis of the vehicle. The rear wheels 2 and 3 for this are pivoted in each case in the opposite direction until they are aligned parallel to one another. For this, the pivotability of the rear wheels 2 and 3 about in each case at least 90° is necessary. The travel perpendicular to the longitudinal axis of the vehicle is possible also even if the front wheel 1 is directed inwards parallel to the rear wheels 2 and 3.

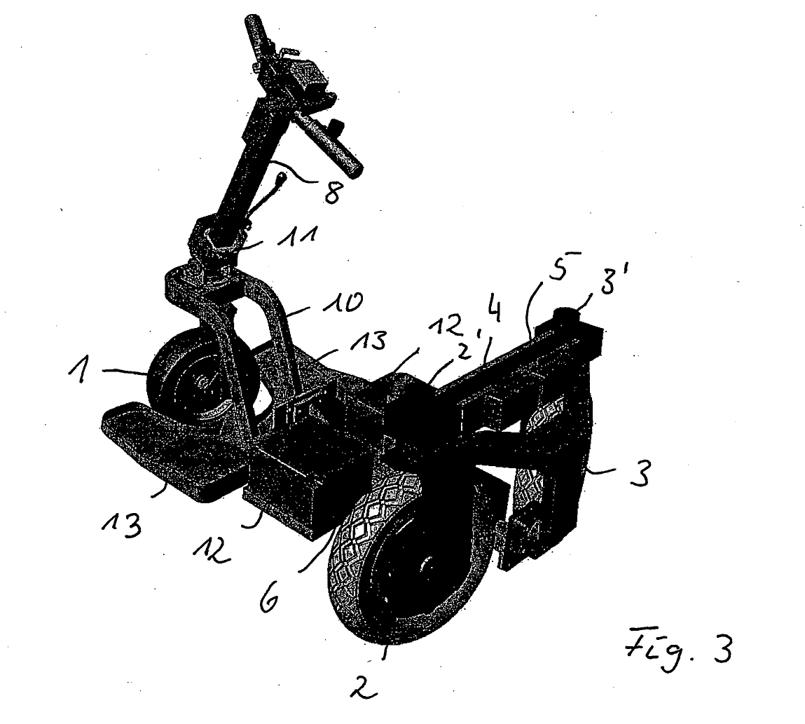

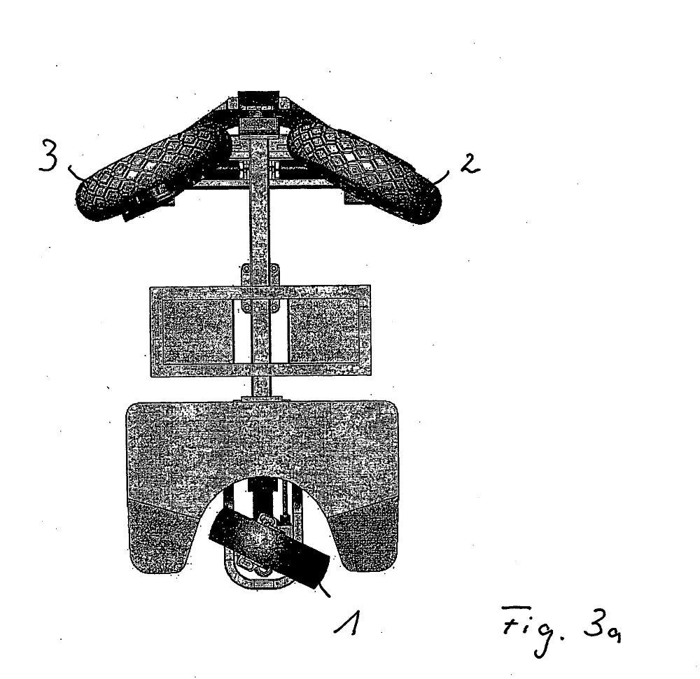

A further possible travel mode for a vehicle according to the invention is to be explained with FIG. 3. Here, the rear wheels 2 and 3 have been pivoted by way of the steering drives 4 and 5 in each case with the same angle but in opposite directions, so that they may at least approximately follow a common radius. With a suitably steered-in front wheel, a movement of the vehicle about its own axis is then possible, so that on rotation, one only requires a space whose diameter corresponds to the length of the vehicle diagonals.

With the travel modes according to the FIGS. 2 and 3, the drives of the rear wheels 2 and 3 are driven in opposite rotational directions, although the rear wheels 2 and 3 indeed rotate in the same direction.

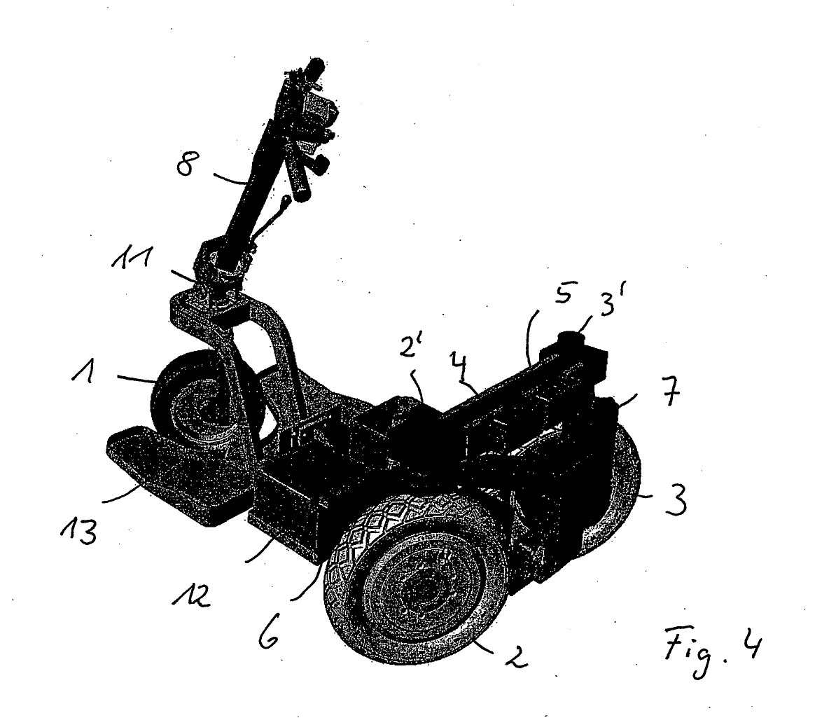

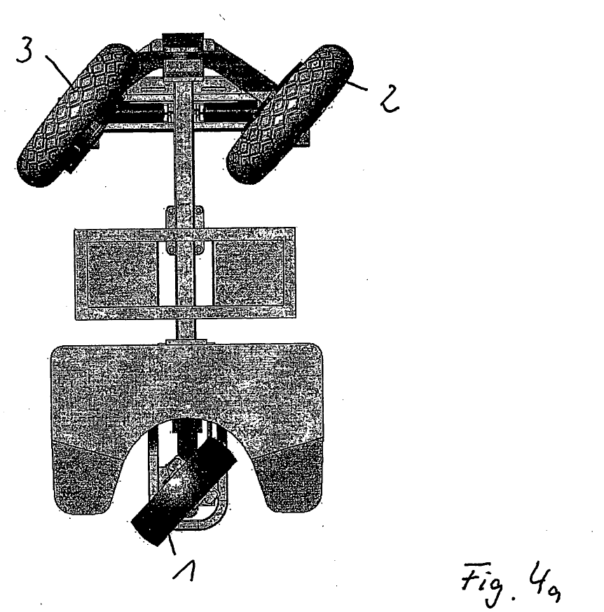

With the vehicle as is shown in FIG. 4, a travel mode has been set which permits oblique travel. Thus the rear wheels 2 and 3 and also the front wheel 1 are pivoted such that they are aligned parallel to one another and the vehicle may travel in this direction. Thereby, the longitudinal axis of the vehicle is aligned at an angle which is inclined obliquely to the travel direction.

1. A vehicle for a handicapped person, comprising:
at least one steerable front wheel; and
a frame;
at least two wheel suspensions;
at least two rear wheels, each of the at least two rear wheels being individually coupled to the frame with a corresponding one of the at least wheel suspensions; and
at least one controllable steering drive driving the at least two rear wheels.

2. A vehicle according to claim 1, wherein at least one steering drive includes a corresponding steering drive for each of the at least two rear wheels.

3. A vehicle according to claim 1, wherein the at least one steering drive is a wheel hub drive.

4. A vehicle according to claim 1, further comprising:
a fork holding the at least one front wheel; and
a steering rod connected to the fork and steering the at least one front wheel.

5. A vehicle according to claim 4, further comprising:
at least one rotational angle sensor situated on the steering rod.

6. A vehicle according to claim 5, further comprising:
an electronic control.

7. A vehicle according to claim 6, wherein at least one of the least one rotational angle sensor and the at least one steering drive is connected to the electronic control.

8. A vehicle according to claim 1, further comprising:
a change-over switch switching between predetermined travel modes, the modes defining an activation of the at least two rear wheels.

9. A vehicle according to claim 4, wherein the steering rod is connected to the fork with one of a cardan joint and a homocinetic joint.

10. A vehicle according to claim 1, wherein the at least one steering drive is a linear motor.

11. A vehicle according to claim 1, further comprising:
a further drive situated on the at least one steering drive, the further drive being one of a spindle drive and a rack drive.

12. A vehicle according to claim 4, wherein the steering rod is pivotable parallel to an axis of the fork between two end abutments.

13. A vehicle according to claim 1, wherein the at least two rear wheels are pivotable by at least 90°.

14. A vehicle according to claim 1, further comprising:
at least one front controllable steering drive controlling the at least one front wheel.

15. A vehicle according to claim 14, wherein the least one front wheel includes first and second front wheels, the at least one front steering drive includes first and second first and second front steering drives, wherein each of the first and second front wheels is controllable and pivotable individually by a corresponding one of the first and second front steering drives.
